(19) United States
(12) Patent Application Publication
(10) Pub. No.: US 2006/0174523 A1
(43) Pub. Date: Aug. 10, 2006

(54) Card in displays

(75) Inventors: John F. Butler, Plano, TX (US); Kevin P. Brailsford, Dallas, TX (US); Christopher P. Meyer, Dallas, TX (US); Scott D. Reed, Plano, TX (US); Christopher L. Turner, Dallas, TX (US)

Correspondence Address: BAKER BOTTS L.L.P., 2001 ROSS AVENUE, SUITE 600, DALLAS, TX, 75201-2980, US

(73) Assignee: Blockbuster Inc.

(21) Appl. No.: 11/051,702

(22) Filed: Feb. 4, 2005

(51) Int. Cl. G09F 3/10

(52) U.S. Cl. 40/299.01; 40/124

(57) ABSTRACT

A system for displaying items includes items for use in a media transaction displayed in a stacked manner that allows consumers to remove a selected item from the items. The system also includes a card located behind the items that indicates the unavailability of the items when the items are removed from in front of the card.

### TECHNICAL FIELD

This invention relates generally to the field of displays and more specifically to a card on a display.

### BACKGROUND

Displays exist in stores to hold items for consumers and to attract consumers to the items. These displays come in many forms. Stores prefer visually impactful displays to attract consumers to the items, while keeping displays in accordance with the stores' overall design or appearance. When consumers remove items from displays, the displays lose their visual impact as empty spaces appear in the display.

### SUMMARY OF THE DISCLOSURE

In accordance with the present invention, disadvantages and problems associated with previous techniques for displays may be reduced or eliminated.

According to one embodiment of the present invention, a system for displaying items includes items for use in a media transaction displayed in a stacked manner that allows consumers to remove a selected item from the items. The system also includes a card located behind the items that indicates the unavailability of the items when the items are removed from in front of the card.

Certain embodiments of the invention may provide one or more technical advantages. One embodiment includes a card that depicts images of an item when a consumer removes the item from a display. Once the items are removed, the card remains to eliminate empty spaces on displays. The invention can be adapted to wall shelves, portable shelves, stand-alone displays, or other merchandising systems. Particular embodiments include a channel that reduces the movement of the card while on the display. The card may also contain inventory indicia and provide an efficient mechanism for moving an inventory of items. The card provides a light, easy to handle, and movable instrument for stores to use in controlling display space.

A particular advantage occurs in digital video disk (DVD) rentals. When all DVDs have been removed from in front of the cards, the card remaining on the display eliminates empty space and informs the consumer that all copies of the particular DVD have been rented. The card also maintains the visual appearance of the display even though the DVDs have been removed.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a card;

FIG. 2 illustrates a comparative view of the card and an associated item;

FIG. 3 illustrates one embodiment of a system for displaying items and cards; and

FIG. 4 illustrates another embodiment of a system for displaying items and cards.

### DETAILED DESCRIPTION OF THE DRAWINGS

FIG. 1 illustrates a card 100 for use in displaying items that are part of a media transaction. Card 100, when visible, indicates to consumers that items are unavailable, while eliminating empty space on displays. Card 100 provides a more efficient inventory process when items are replenished or moved from one display to another. In general, card 100 includes an image 102, such as the title artwork of a digital video disk (DVD), which presents a uniform appearance even when consumers remove the items.

Card 100 indicates the unavailability of an item when consumers remove the items from a display and only card 100 remains. Card 100 may be plastic, cardstock, paperboard, or any suitable card that may indicate the unavailability of items. In the illustrated embodiment, card 100 is formed from a polystyrene plastic to provide card 100 with stability on a display and resistance from damage. In another embodiment, a plastic case may surround card 100 to provide further protection and stability. In the illustrated embodiment, card 100 has a thickness of approximately 0.031 millimeters to 0.033 millimeters. The particular thickness of card 100, which is typically thinner than the items, can also convey to the consumer that card 100 does not contain media.

Image 102 indicates the specific item to the consumer. In the illustrated embodiment, image 102 includes the title artwork of the item, such as a DVD. Image 102 may be integral to card 100 or affixes to card 100 in any suitable manner. For example, image 102 may affix to card 100 by printing image 102 onto card 100, by gluing image 102 onto card 100, by taping image 102 onto card 100, or any suitable process. Image 102 may appear anywhere on card 100 to indicate the item to the consumer. In the illustrated embodiment, image 102 appears only on the side of card 100 positioned outward from the display, the front of card 100. In another embodiment, image 102 may appear on the front of card 100 and the side of card 100 positioned inward to the display, the back of card 100, which allows card 100 to be placed in either orientation on the display. In another embodiment, image 102 may differ from front to back. For example, image 102 may include title artwork on the front of card 100 and include a synopsis of the item on the back of card 100. The synopsis of the item may briefly describe the item; provide important information about the item, such as length, compatibility, or price; or provide reviews of the item. For example, if the item is a DVD, the synopsis may include a short description of the movie plot, a list of actors in the movie, the length of the movie, and a Motion Picture Association of America movie rating.

Index 104 indicates information for store personnel. Index 104 may indicate inventory information, which increases the efficiency of the inventory process. The inventory information may include data about the number of items in the store, the number of items at an off-site location, or any suitable inventory information. In a particular embodiment, index 104 is a bar code, radio frequency identification (RFID) tag, or other machine or human readable information. For example, if card 100 represents a DVD, index 104 is a code that provides inventory information for use in renting, selling, or inventorying the DVD selection.

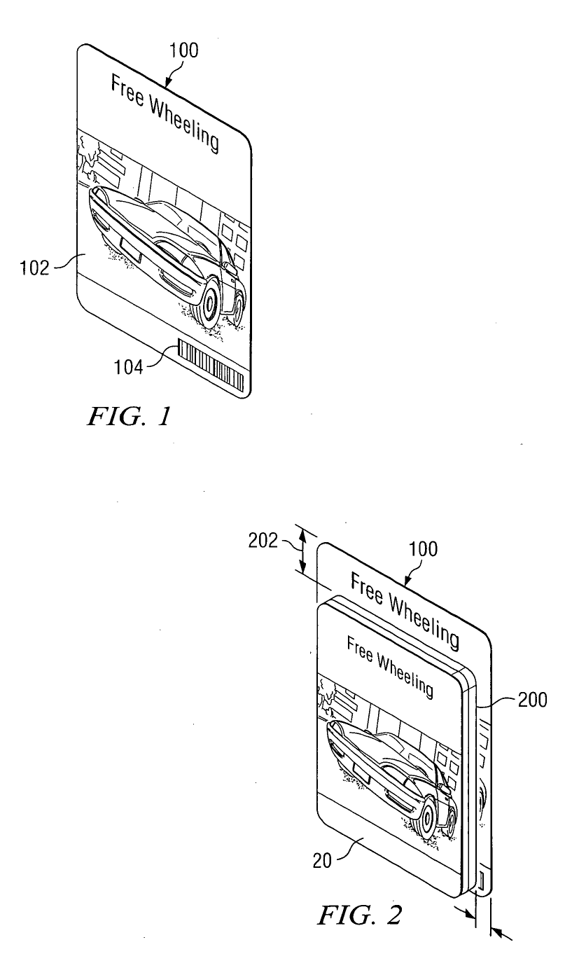

FIG. 2 illustrates a card 100 as compared to an item 20. In the illustrated embodiment, the size of card 100 extends outwardly from item 20, which provides visibility of card 100 when placed behind item 20.

Item 20 is an item a consumer intends to obtain for use in a media transaction. Item 20 may include any suitable media that a consumer would like to obtain. The media may include a book, a movie in video home system (VHS) format, a movie on a digital video disk (DVD), a game that operates on various gaming systems, a compact disk, or any suitable item appropriate to display. Upon obtaining item 20, the consumer uses item 20 in a media transaction. The media transaction may include purchasing item 20, borrowing item 20 for later return to the store, trading item 20 for another item 20, or any suitable transaction involving media. In the illustrated embodiment, a container 200 holds item 20. Container 200 may include any suitable holder that holds item 20, such as a plastic case. Container 200 protects item 20 from damage, exposure, or other possible harmful occurrences. For example, if item 20 is a DVD, the DVD is enclosed in a plastic case, such as an AMARAY case, to prevent scratching from exposure. In another embodiment, item 20 may not include container 200.

Card 100 may be any suitable size. In the illustrated embodiment, card 100 is greater than the size of item 20 and remains visible when placed behind item 20. Because card 100 remains visible behind item 20, a consumer can distinguish between card 100 and item 20. Image 102 may be slightly enlarged to accommodate the larger card 100. Including an enlarged image on card 100 presents a consistent visual appearance on displays.

Extension 202 of card 100 above item 20 allows for easy separation between card 100 and the last item 20. For example, when item 20 is in front of card 100 of a similar size, a consumer may grasp both item 20 and card 100 when only intending to grasp item 20. The extension of card 100 around item 200 eliminates this occurrence and permits a consumer to recognize the difference between card 100 and item 20, thereby grasping only the intended item 20. Extension 202 may also include any suitable information to identify item 20, such as graphics, slogans, or titles. For example, if item 20 is a DVD, extension 202 may include the DVD's title.

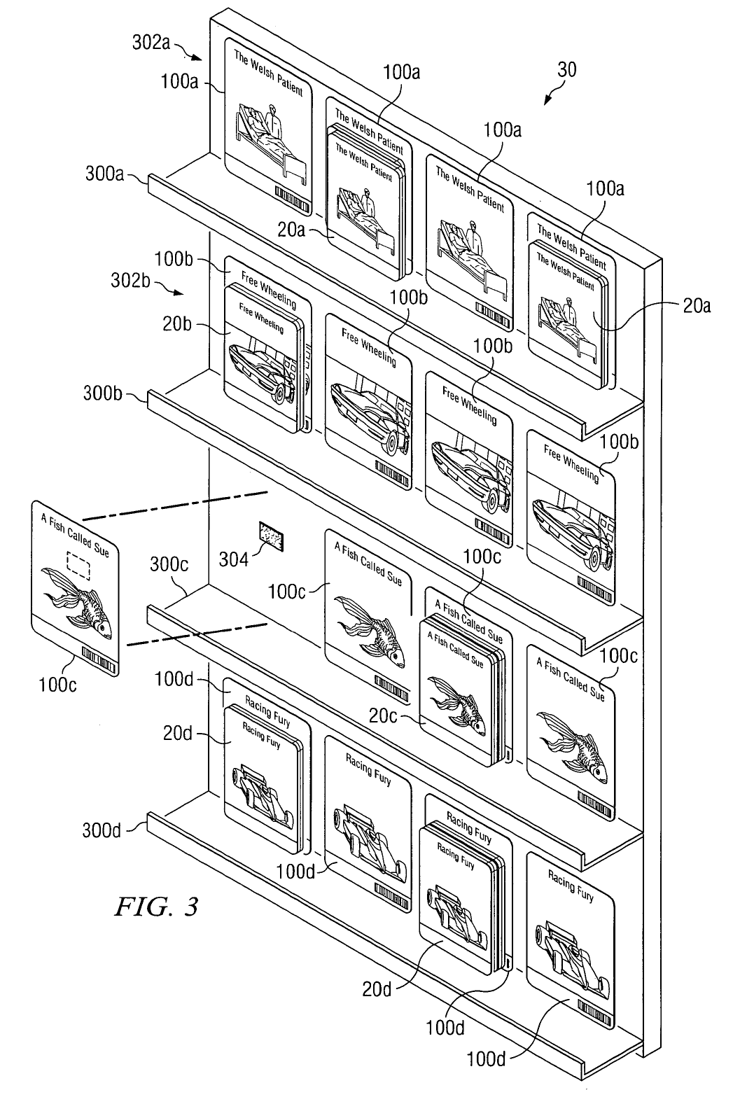

FIG. 3 illustrates a system 30 for displaying one or more items 20 for use in a media transaction. System 30 includes one or more shelves 300a-d that hold one or more cards 100a-d and items 20a-d.

Shelves 300a-d provide support for cards 100a-d and items 20a-d. Shelves 300a-d may include wooden shelves, wire shelves, metal shelves, plastic shelves, cardboard shelves, or any suitable shelf that may hold cards 100a-d and items 20a-d. In the illustrated embodiment, shelves 300a-d are arranged horizontally and items 20a-d are stacked in front of cards 100a, 100b, 100c, and 100d. Shelves 300a-d may be arranged in any suitable manner to enhance the display of items 20a-d. Stacking the items 20a-d, for example, includes placing items 20a together and placing the grouping of items in front of card 100a.

A facing 302 refers to card 100 or card 100 and a group of items 20 associated with card 100 that are displayed on shelves 300a-d. For example, facing 302a includes card 100b and a group of items 20b, while facing 302b only includes card 100b. Shelves 300a-d may contain any number of facings 302a-b, and facings 302a-b may be arranged in any suitable manner on shelves 300a-d. In the illustrated embodiment, facing 302a and facing 302b depict different items 20. In another embodiment, multiple facings 302 may depict the same item 20.

Cards 100a-d may depict any item 20 or any number of items 20a-d when displayed on shelves 300a-d. For example, if item 20 is a DVD, shelf 300a may include different titles of DVDs on the same shelf 300a. The different DVD titles may also be on different shelves 300. In the illustrated embodiment, shelf 300a supports four cards 100a that depict item 20a. On shelf 300a, two cards 100a have items 20a available for the consumer, while two cards 100a do not have items 20a in front of them. Even though cards 100a do not have items 20a in front of them, shelf 300a has a uniform appearance without empty space on shelf 300a that maximizes the display space for advertising items 20 to consumers.

Shelf 300b includes cards 100b; the first card 100b has items 20b in front of it. Even though the remaining cards 100b do not have items 20b in front of them, system 30 continues to have a uniform appearance without empty facings 302.

Shelf 300c includes cards 100c and items 20c in front of the third card 100c. The first card 100c illustrates an attachment mechanism 304 to prevent card 100c from inadvertently moving. In the illustrated embodiment, attachment mechanism 304 attaches card 100c to shelf 300c. In another embodiment, attachment mechanism 304 may attach card 100 to the wall or any other surface for displaying items 20. Attachment mechanism 304 may be Velcro, tape, adhesive, glue, a magnet, or any suitable mechanism to attach card 100c to shelf 300c and to prevent card 100c from inadvertently moving. Any card 100 may include attachment mechanism 304. Shelf 300d includes cards 100d with items 20d in front of the first and third cards 100d.

Arranging cards 100 and items 20 into facing 302 on shelves 300, as described above, also eases the inventory process. Facing 302, which includes card 100 and a group of items 20, may be moved between shelves 300 by picking up facing 302 and placing facing 302 on another shelf 300. Additionally, items 20 may be easily replenished using index 104 to obtain inventory information, retrieving items 20, and placing additional items 20 in front of card 100.

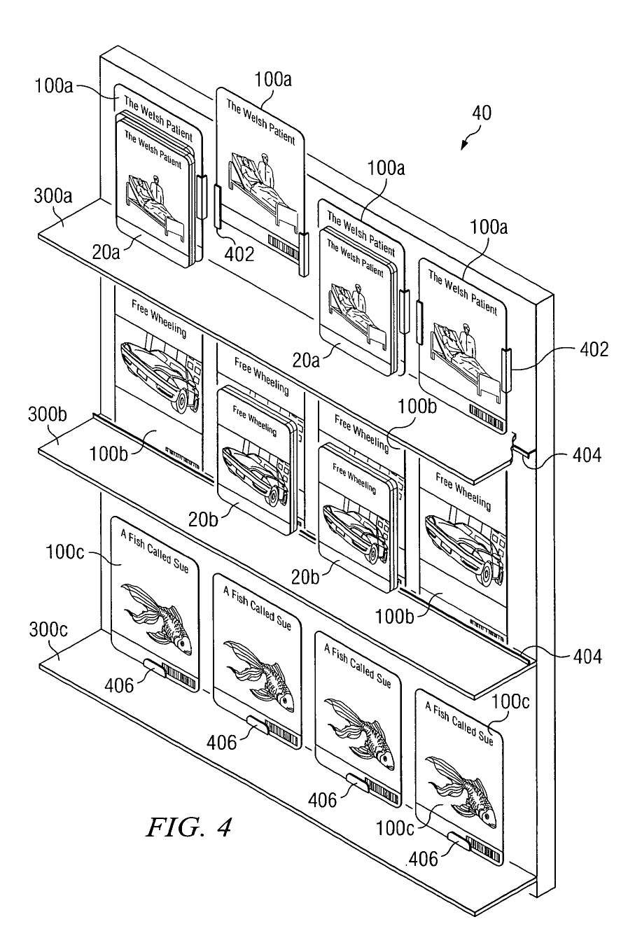

FIG. 4 illustrates a system 40 for displaying one or more items 20 for use in a media transaction. System 40 includes one or more shelves 300a-c that hold one or more cards 100a-c and items 20a-c with vertical channels 402, horizontal channels 404, and ridges 406 to support cards 100a-c and substantially reduce the unintended movement of cards 100a-c.

Cards 100a on shelf 300a have vertical channels 402 that hold cards 100a to shelf 300a. In the illustrated embodiment, cards 100a have vertical channels 402 on both sides of card 100a. Vertical channels 402 may be arranged in any suitable manner to hold card 100. For example, vertical channels 402 may extend the height of card 100. Vertical channels 402 may be made of metal, plastic, or any suitable material strong enough to keep cards 100a in place and durable enough to withstand continual removal and addition of cards 100a.

Horizontal channels 404 hold cards 100b in place. In the illustrated embodiment, horizontal channels 404 extend the length of shelf 300b and hold cards 100b on the top and bottom. In another embodiment, horizontal channels 404 hold cards 100b on the top or the bottom and do not extend the length of shelf 300b. For example, horizontal channels 404 may hold cards 100b on the bottom. In yet another embodiment, horizontal channels 404 include an inset to insert cards 100b. The inset ensures that cards 100b do not move within horizontal channels 404.

Shelf 300c includes ridges 406 that hold cards 100c and decrease the unintended movement of cards 100c. In the illustrated embodiment, each card 100c is placed in separate ridges 406. In another embodiment, ridge 406 may extend the length of shelf 300c and any number of cards 100c may fit into ridge 406.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A card for use in a display, comprising:
a card substantially located behind a plurality of items, the card indicating an unavailability of the items when the items are removed; and
an image on the card, the image indicating content of the items and providing a consistent visual appearance even after the items are removed.

2. The card of claim 1, further comprising machine-readable inventory information associated with the items.

3. The card of claim 2, wherein the machine-readable inventory information comprises a bar code.

4. The card of claim 1, wherein the card having a thickness of approximately 0.031 millimeters to 0.033 millimeters.

5. The card of claim 1, wherein the card is formed from a polystyrene plastic.

6. The card of claim 1, wherein the card is substantially rectangular having a perimeter that is greater than a perimeter of the item to allow a consumer to distinguish the card from the item.

7. The card of claim 6, wherein the card and its associated image extend beyond the item to allow a consumer to partially view the image on the card behind the item.

8. The card of claim 1, further comprising an attachment mechanism to couple the card to a back surface and prevent removal of the card by the consumer.

9. The card of claim 1, wherein the image on the card comprises:
a first image depicting the item on a first side of the card; and
a second image depicting a synopsis of the item on a second side of the card opposite the first side.

10. The card of claim 9, wherein:
the first image comprises studio art of a movie on the first side; and
the second image comprises textual movie information, including at least actors, a director, and a short description of the movie plot on the second side of the card opposite the first side.

11. The card of claim 1, wherein the image on the card is the same on a first side of the card and a second side of the card opposite the first side.

12. A system for displaying items for use in a media transaction, comprising:
a plurality of items for use in a media transaction displayed in a stacked manner that allows a consumer to remove a selected item from the items; and
a card located behind the items, the card indicating the unavailability of the items when the items are removed from in front of the card.

13. The system of claim 12, wherein the card comprises an attachment mechanism to couple the card to a back surface and prevent removal of the card by the consumer.

14. The system of claim 12, wherein the plurality of items comprises a plurality of media.

15. The system of claim 12, wherein the plurality of items comprises a plurality of containers.

16. The system of claim 15, wherein a container of the plurality of containers comprises media.

17. The system of claim 16, wherein the media comprises a digital video disk (DVD).

18. The system of claim 12, further comprising a ridge coupled to the surface, the ridge operable to substantially decrease movement of the card.

19. The system of claim 12, further comprising a channel coupled to the surface, the channel operable to substantially decrease the movement of the card.

20. A system for displaying items for use in a media transaction, comprising:
a plurality of items for use in a media transaction displayed in a stacked manner that allows a consumer to remove a selected item from the items;
a card located behind the items, the card indicating the unavailability of the items when the items are removed from in front of the card; and
a plurality of shelves operable to display the plurality of items and the card in a facing, the plurality of shelves operable to display a plurality of facings.

21. The system of claim 20, wherein the card comprises an attachment mechanism to couple the card to a back surface of the plurality of shelves and prevent removal of the card by the consumer.

22. The system of claim 20, wherein the plurality of items comprises a plurality of media.

23. The system of claim 20, wherein the plurality of items comprises a plurality of containers.

24. The system of claim 23, wherein a container of the plurality of containers comprises media.

25. The system of claim 24, wherein the media comprises a digital video disk (DVD).

26. The system of claim 20, further comprising a ridge coupled to the plurality of shelves, the ridge operable to substantially decrease movement of the card.

27. The system of claim 20, further comprising a channel coupled to the plurality of shelves, the channel operable to substantially decrease the movement of the card.

28. A system for displaying digital video disks (DVDs) for use in a media transaction, comprising:
a plurality of DVDs displayed in a stacked manner that allows a consumer to remove a selected DVD, each DVD having a container that holds media; and
a card located behind the DVDs, the card indicating the unavailability of the DVDs when all of the DVDs are removed from in front of the card, the card having a thickness of approximately 0.031 millimeters to 0.033 millimeters and formed from a polystyrene plastic, the card being substantially rectangular and having a perimeter that is greater than a perimeter of the DVDs to allow a consumer to distinguish the card from the DVDs, the card further comprising an image substantially similar to an image on the DVDs to provide a consistent visual appearance even after the DVDs are removed, wherein the card and its associated image extend beyond the DVDs to allow the consumer to partially view the image on the card behind the DVDs.
